(19) United States
(12) Patent Application Publication
(10) Pub. No.: US 2003/0021398 A1
(43) Pub. Date: Jan. 30, 2003

(54) Portable symbol

(75) Inventors: Peter Gerald Donnelly, Yarraville (AU); Colin Keith Goodwin, Mt. Waverley (AU)

Correspondence Address: OLIFF & BERRIDGE, PLC, P.O. BOX 19928, ALEXANDRIA, VA, 22320, US

(73) Assignee: Telstra New Wave Pty Ltd., Melbourne (AU)

(21) Appl. No.: 10/176,526

(22) Filed: Jun. 24, 2002

Related U.S. Application Data
(63) Continuation of application No. PCT/AU00/01591, filed on Dec. 22, 2000.

(30) Foreign Application Priority Data
Dec. 24, 1999 (AU) PQ4895
May 10, 2000 (AU) PQ7531

(51) Int. Cl. H04M 11/00

(52) U.S. Cl. 379/93.17

(57) ABSTRACT

A symbol for establishing a telephone call, has the following characteristics: (a) the symbol appears on a computer display; (b) a user can select and activate the symbol, which causes computer software associated with they symbol to activate telecommunications equipment which establishes the telephone call; (c) the symbol is “portable”, in that a user can cause it to be moved from any one of the following locations: (i) an Internet web page, (ii) an email message, (iii) a window associated with a computer program, (iv) a file directory folder, (v) and electronic form, (vi) a computer data storage medium, (vii) the user's operating system “desktop”, (viii) a personal digital assistant, Wireless Application Protocol phone or other mobile computing device; to one of the following locations: (I) the user's operating “desktop”, (II) an email message, (III) a window associated with a computer program, (IV) a file directory folder, (V) an electronic form, (VI) a computer data storage medium, (VII) an Internet web page, (VIII) a personal digital assistant, Wireless Application Protocol phone or other mobile computing device: (d) when the symbol is moved from one location to another, computer software and data associated with the symbol is copied to the new location together with the symbol, the computer software and data being sufficient to facilitate the establishment of a telephone call.

### FIELD OF THE INVENTION

This invention relates to a portable symbol. It relates particularly but not exclusively to a symbol for establishing a telephone call and to a portable symbol with a stored value. The invention will be described with particular reference to the field of telephony, but it is to be understood that the invention has more general application.

### BACKGROUND TO THE INVENTION

There are various known ways of establishing a telephone call using a graphical interface. One example involves a telephone system which has a visual display. A user may see the status of current calls on the visual display, and different actions such as initiating a new call may be undertaken by selecting various displayed items.

In another example, a PC may be equipped with a, software and/or hardware system which enables it to initiate telephone calls when instructed by other software within the PC. Here, a local interface exists between the PC and a telephone or telephone service or telephone network.

U.S. Pat. No. 5,533,110 describes a human machine interface for telephone feature invocation. An icon representing a user is provided on a display together with a call set-up icon. The user drags the icon representing himself or herself to the call set-up loon, and then selects the identity of another person from a directory of subscribers, and drags the identity of that other person to the call set-up icon. This results in a telephone call being established with the other person, whereupon the call set-up icon changes its appearance to indicate that the call is in progress. This provides a visual way of controlling telephone calls.

A slightly different concept known as “Click to Dial” is described in U.S. Pat. No. 5,991,394. In this arrangement, the computer user locates an Internet web sits which has on it a “Call Me” or “Click to Dial” button. If the user clicks on or activates this button, a telephone call is set up between the user and a person associated with the web site (usually a business selling a product or service which interests the user). The resulting telephone call may involve ordinary telephone handset(s) or else PC based (soft) handset(s). The user may register his or her telephone number at the time of clicking to request the call, or the user's number may be pre-registered, in which case a single click may be all that is required to request the call.

The mechanism for establishing the call for an ordinary telephone connection involves a server application associated with the web site displaying the “Click to Dial” button sending a request to a telephone switching system or “Intelligent Network” (IN) software system which is capable of setting up a call between the person associated with the web site and the user. The telephone switching system is usually an Automatic Call Distributor (ACD) or a telephone company switch network. In the latter case a call set-up request is sent from the server to the phone company switch through a standardised (SS7 or IN) or proprietary interface. The switch causes a call to be set up in Call Back mode. In other words, the user clicks the “Click to Dial” button, the user's phone rings, the user picks up the phone, and a recorded voice says “Please hold, your call is being connected.” This system is useful to enable people browsing Internet web sites to speak to a real person to ask further questions. However, with this technique, the system requires the user to locate the appropriate web site before a call can be made. Once the user has left the web site, the ability to make the call disappears unless the user has written down or memorised the number. It would be desirable both for the web site operator and for the user if the ability to establish contact by telephone in the convenient “Click to Dial” manner could continue after the user leaves the web site.

### SUMMARY OF THE INVENTION

According to a first aspect of the present invention, there is provided a symbol for establishing a telephone call, having the following characteristics:

(a) the symbol appears on a computer display;

(b) a user can select and activate the symbol, which causes computer software and data associated with the symbol to activate telecommunications equipment which establishes the telephone call;

(c) the symbol is “portable”, in that a user can cause it to be moved from any one of the following locations:

(i) an Internet web page

(ii) an email message

(iii) a window associated with a computer program

(iv) a file directory folder

(v) an electronic form

(vi) a computer data storage medium

(vii) the user's operating system “desktop”

(viii) a personal digital assistant, Wireless Application Protocol phone or other mobile computing device

to one of the following locations:

(I) the user's operating system “desktop”

(II) an email message

(III) a window associated with a computer program

(IV) a file directory folder

(V) an electronic form

(VI) a computer data storage medium

(VII) an Internet web page

(VIII) a personal digital assistant, Wireless Application Protocol phone or other mobile computing device;

(d) when the symbol is moved from one location to another, the computer software and data associated with the symbol are copied to the new location together with the symbol, the computer software and data being sufficient to facilitate the establishment of a telephone call. The software and data associated with the symbol may be located on the same computer as the symbol or on other computer(s) or on both.

Where visual representations of more than one of the locations mentioned in (c) are simultaneously present on a computer display then the process described in (d) may be accomplished by means of a drag and drop action using a mouse or other input device.

It will be seen that, amongst many possible applications, the present invention allows a user to “save” or drag a “Click to Dial” button off a web page for later use. The particular locations given above from which and to which a symbol can be dragged are examples only, representative of the many places a symbol may be located. It is envisaged that in normal usage, symbols can be freely dragged from location to location in multistep moves. For example, a symbol might be dragged off a web page and onto a desktop, and then from the desktop into a “Symbols” folder, or into an e-mail to send to a friend. The symbol is therefore as portable and substrate-independent as possible.

The computer software which is activated when the symbol is selected and activated may give the user an option to select by name or number or function the telephone number to which the telephone call is to be established, and the option may be provided in the form of a list. This option allows, for example, a business to provide a single symbol or button which can be used by the user to establish a call with any one of a number of different employees within the business. This option also allows a business to give the user a “free” telephone call (or series of calls, perhaps with a limited total value) to any telephone number or a selected set of numbers. In this arrangement, the business would pay for the calls made by the user.

Alternatively, the symbol may be associated with a single telephone number, and the computer software which is activated when the symbol is selected causes establishment of a telephone call to that number only. This option allows a person to use the symbol or button essentially as a business card.

The symbol may be associated with a stored value, such that when the user uses the symbol to establish a telephone call, the stored value is reduced by an amount associated with the value of the telephone call. Thus, for example, a user purchasing a product may receive a symbol or button entitling that person to telephone support calls to the value of $100. Alternatively, a telephone carrier might offer promotional symbols or buttons entitling the user to $5 worth of free calls using the telephone carrier's network.

A symbol according to the invention may be used as an indicator to the user that the user is requested or required to make a telephone call to a particular number, with the symbol disappearing or changing its appearance as the call is set up or after the user has used it to establish the telephone call. Thus, for example, a receptionist taking call-back messages for employees within a business could provide those messages in the form of symbols or buttons, rather than in the traditional form of a hand-written note. The buttons would be displayed on the employee's computer display, each button indicating a call which needs to be returned and holding the message that was left so that the recipient can view or listen to the message then dick to return the call.

According to another aspect of the present invention there is provided a portable symbol with a stored value, having the following characteristics:

(a) the symbol appears on a computer display,

(b) a user can select and activate the symbol, which causes computer software and data associated with the symbol to conduct a transaction which has an associated cost;

(c) the symbol is “portable”, in that a user can cause it to be moved from any one of the following locations:

(i) an Internet web page

(ii) an email message

(iii) a window associated with a computer program

(iv) a file directory folder

(v) an electronic form

(vi) a computer data storage medium

(vii) the user's operating system “desktop”

(viii) a personal digital assistant, Wireless Application Protocol phone or other mobile computing device

to one of the following locations:

(I) the user's operating system “desktop”

(II) an email message

(III) a window associated with a computer program

(IV) a file directory folder

(V) an electronic form

(VI) a computer data storage medium

(VII) an Internet web page

(VIII) a personal digital assistant, Wireless Application Protocol phone or other mobile computing device;

(d) when the symbol is moved from one location to another, the computer software and data associated with the symbol are copied to the new location together with the symbol, the computer software and data being sufficient to facilitate the transaction which has the associated cost;

(e) when a transaction is conducted, the associated cost is deducted from the stored value.

Where visual representations of more than one of the locations mentioned in (c) are simultaneously present on a computer display then the process described in (d) may be accomplished by means of a drag and drop action using a mouse or other input device.

The stored value may be stored in a database local to or remote from the location of the computer software and data associated with the symbol. Whenever the user activates the symbol or button, the database checks to see whether there is sufficient stored value associated with the symbol or button to permit the transaction to proceed. If there is insufficient stored value, a message may be sent to the user inviting the user to add value to the symbol or button, purchase another symbol or button, or provide payment for the transaction in some other suitable manner.

Alternatively, the stored value may be stored as part of the computer software and data associated with the symbol. Whenever the user activates the symbol or button an internal check is made to determine whether there is sufficient stored value to permit the transaction to proceed. If there is insufficient stored value, the options listed In the preceding paragraph may apply.

According to a third aspect of the invention, there is provided a collection of symbols or buttons wherein each symbol represents a different type of transaction or a transaction with a different person. It is envisaged that many different business will offer symbols or buttons according to the invention, and users will maintain collections of ones which are particularly relevant to their needs and lists of contacts. Businesses may use their trade marks as symbols.

It is preferred that the transactions associated with the symbols consist of or include establishing telephone calls, but this need not be the case. The symbol can be regarded as a portable actuator of transactions.

### BRIEF DESCRIPTION OF THE DRAWINGS

The invention will now be described in greater detail by reference to the attached drawings which show an example form of the invention. It is to be understood that the particularity of the drawings does not supersede the generality of the foregoing description of the invention.

FIGS. 1a through 1h show the invention advantageously applied in a Click-to-Dial context, while FIGS. 2 through 5 illustrate other features and benefits of the invention.

### DETAILED DESCRIPTION

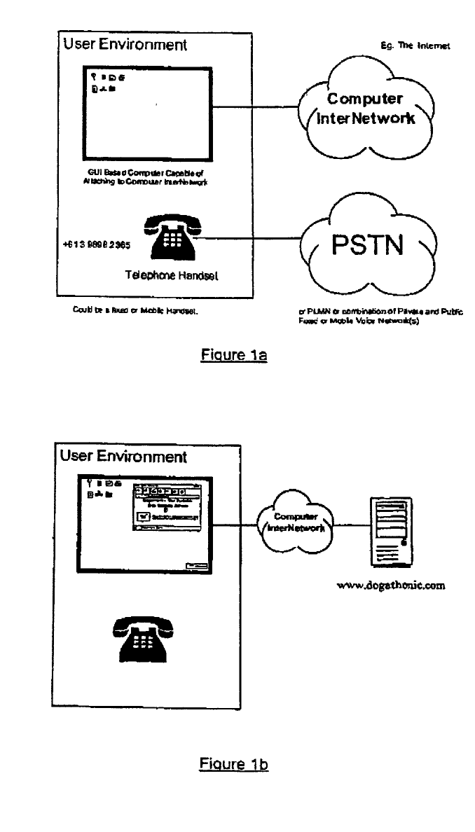

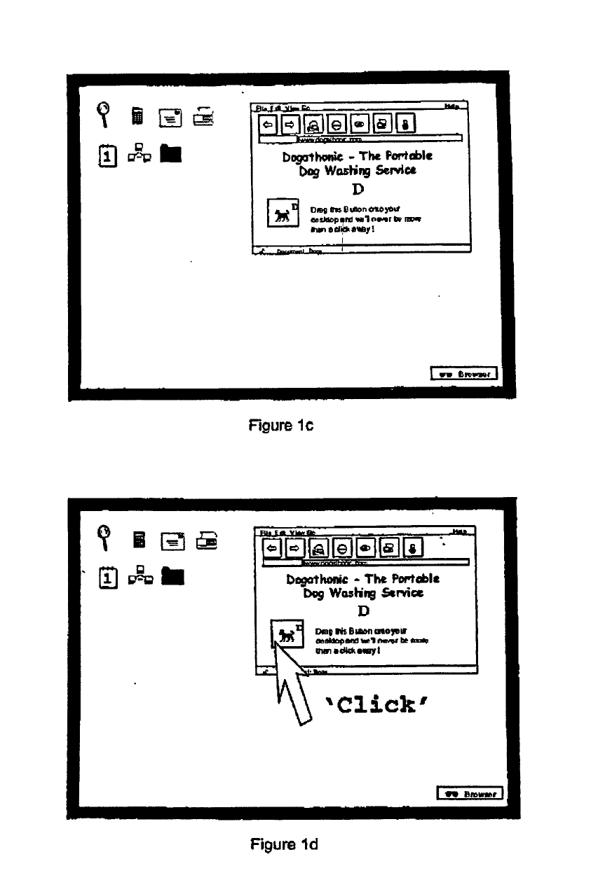

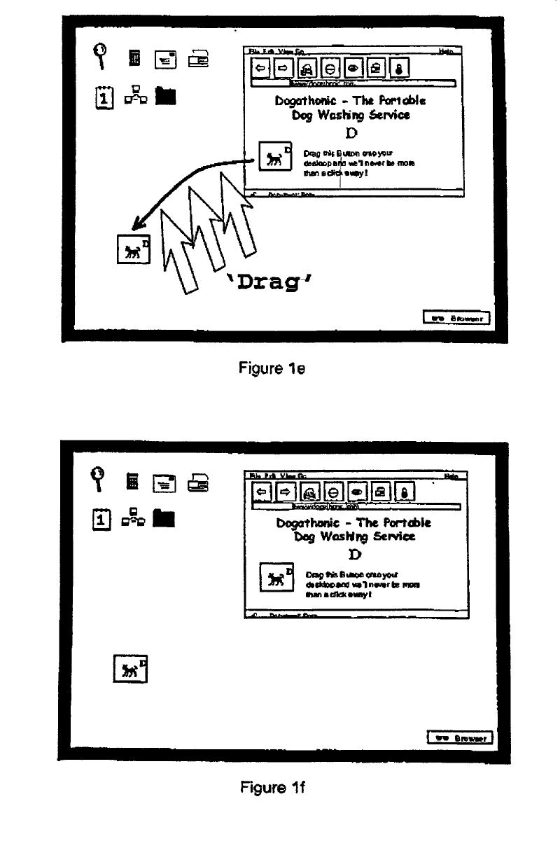

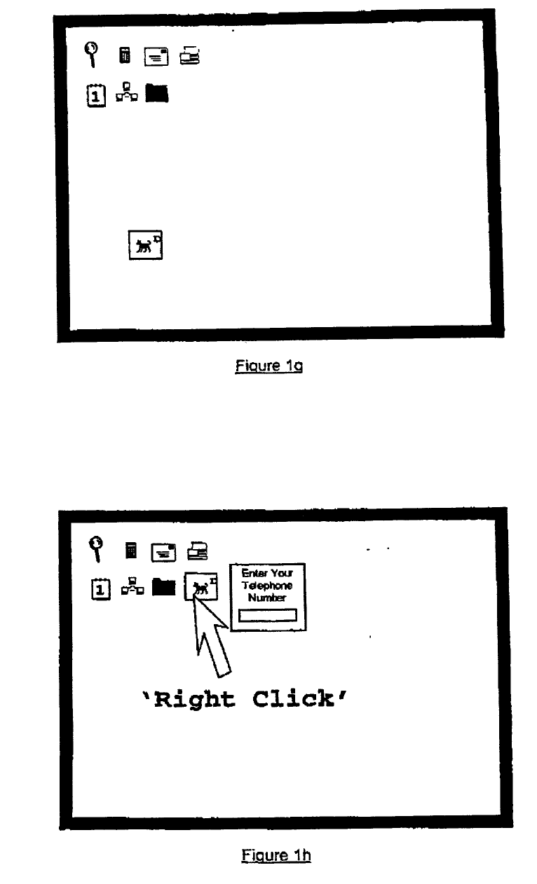

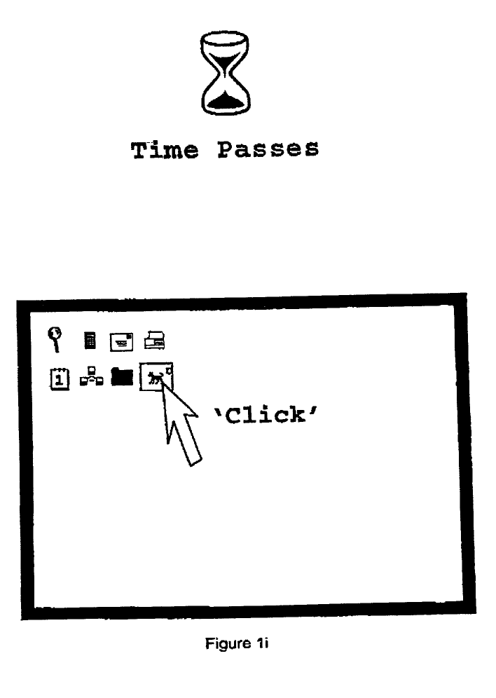

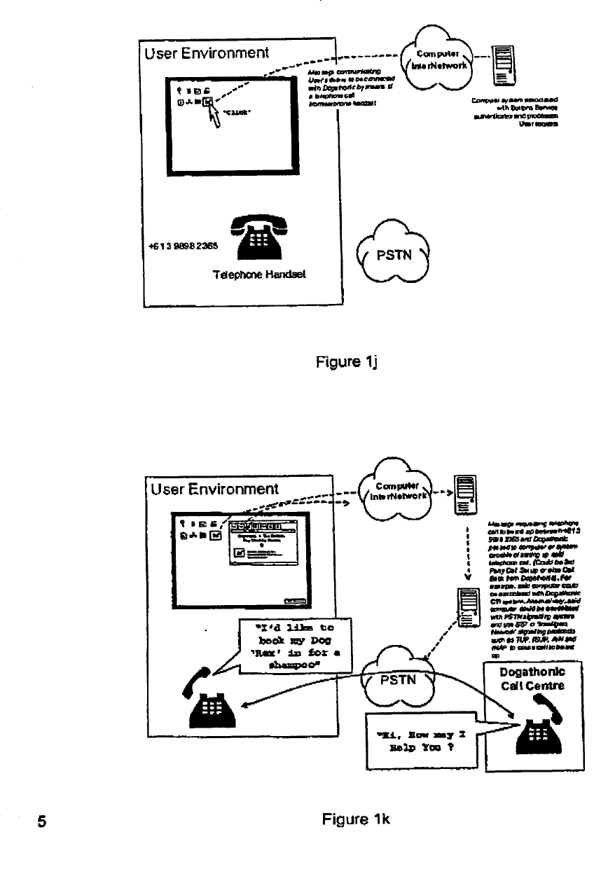

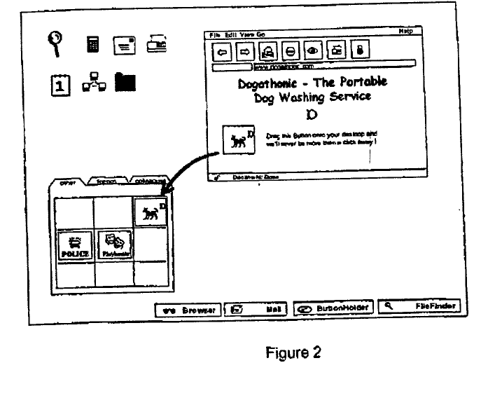

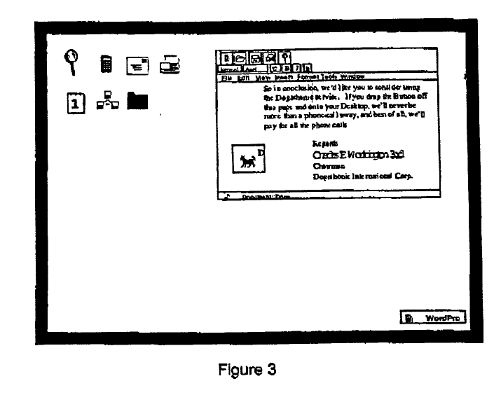

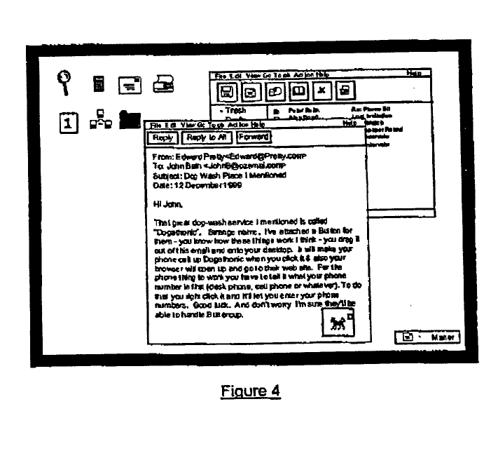

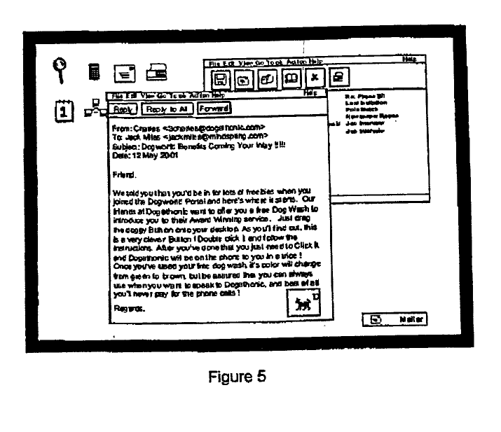

FIGS. 1a through 1h is a series of diagrams which shows 3^{rd} Party telephone call set-up such as might be seen in a Click-to-Dial service operated by a Carrier. In other scenarios, and where the Users PC has the ability to initiate a telephone call—for example by means of an auto-dialler or some other local interface to a telephone, telephone service or telephone network—Call Set-Up may be carried out entirely locally under the control of the User's PC.

It is to be understood that this is one of many possible implementation scenarios.

FIG. 1a shows that the User has available a Personal Computer capable of attaching to the Internet, and in addition has available a standard telephone.

FIG. 1b shows the User browsing a particular business's web site.

FIG. 1c is a close up of the User's display at the same point in time as FIG. 1b. Text on the web page invites the user to drag a Button off the Web Site and onto his or her desktop.

In FIG. 1d the User cracks the Button . . .

. . . and in FIG. 1e performs a dragging movement and releases. The click, drag and release action causes software and data associated with the button to be downloaded to the user's computer and subsequently causes a visual facsimile of the Button to be installed on the user's desktop. Optionally, the dragging process may also be animated, in similar fashion to local drag and drop actions as seen in contemporary graphical operating system display environments.

At FIG. 1f, the download has been completed, any necessary software installed and visual facsimile in place on the desktop. The downloaded software may or may not need to be installed at this point depending on the capabilities of the operating system. Where installation is necessary, then this it is preferred that this occurs without user intervention.

In FIG. 1g, the User has closed down the Web Browser and may also have closed down any network connection. This step illustrates that the User retains the easy ability to call the business even though the business's web page is no longer present. This is seen as a key advantage over present forms of Click-to-Dial.

At FIG. 1h, the User has moved the Button into an alternative location on the desktop and is now in the process of configuring the Button. (Note that the potential to call remains even if no applications are open. Note further that Buttons are intended to inhabit the User's desktop in the same fashion as other, kinds of visual symbols such as those representing programs or documents.) The User configures the Button by entering the telephone number of his/her desk telephone and other information required by the particular system. If the User has previously used this particular Buttons service—perhaps by downloading another business's Button at some earlier point in time—then this information may be already known the Button provider, in which case the configuration step may be omitted; the Button either arriving pre-configured or else locally extracting the necessary information from a pre-existing cookie.

An arbitrary amount of time passes.

In FIG. 1i, the User has decided to contact the Business and clicks the Button. The Web Browser does not have to be open at this time nor at any time during subsequent steps.

The PC may or may not be network attached at this time. If it is not, software associated with the Button causes it to become network attached after this point.

FIG. 1j shows that as consequence of clicking the button, a message is sent to a server requesting that a phone call be set up between this User's telephone and the Business in question.

FIG. 1j shows completion of the call set-up process, using Click-to-Dial precepts or else by means of Call Back from the Business's Call Centre.

FIGS. 2 through 5 illustrate additional benefits of the inventions.

FIG. 2 shows that Users may accumulate Buttons in ‘holders’ designed for this purpose (as an alternative or in addition to accumulating them on the ‘Desktop’ or Operating System Graphical user Interfere). Advantageously a button holder may automatically synchronise data held within held buttons with data located elsewhere such as in a PC or Network based personal address book.

FIG. 3 shows a Button embedded within a Document which will be (or has been) distributed electronically. In FIG. 4 an individual has received an email from a friend which has an embedded Button. Businesses will like the way Buttons makes it easy for one person to recommend a service or product to another person a straightforward and reliable compared to word of mouth (easily forgotten) or scribbled note (easily lost) and further the way it makes initiating the first contact very easy for a potential customer.

FIG. 5 shows that Buttons can be mass emailed out, for example as a part of marketing campaigns. Note that should the recipient of this email not wish to avail themselves of the free offer, it would be trivially easy for them to forward it to one of their friends of colleagues who might wish to avail themselves of the offer.

In order to use a symbol or button, the user does not need to have a web. browser open at the time.

Buttons can be implemented in numerous different ways. In one suitable arrangement, a button may be an HTTP client Alternatively, a button may be a Java applette, or any other suitable type of application. The software infrastructure that supports the button feature may be built into the operating system or separate from the operating system.

Buttons may be pasted by the user into other windows and applications. Thus, for example, a user may choose to send a button to a friend via email. In addition, or as an alternative, to using an Internet web site for distributing buttons, a business may send buttons out to customers using email, or embed them in electronic forms or within software distributed on floppy disks or CD-ROMS or smart cards. When a button is distributed on data storage media such as a CD-ROM, floppy disk or smart card, the button is not visible until it is moved onto an active computing platform.

If buttons are made visually appealing, they provide users with a novel and fun way of exchanging contact information, and businesses with a commercially valuable way of presenting brand or other information to customers/markets, They can be used as a form of automatically-dialling, business card, and can be used on personal web sites as well as on business sites.

One sample application might be in providing support for a product such as a software package. The person purchasing the package is entitled to two hours of telephone support for the first year. A button comes with the software, and the user drags this onto his or her desktop. When the user needs support, he or she clicks on the button to place a telephone call to the help desk. After the two hours have been used up, or after the year has expired, the button becomes inactive and the user may receive a message inviting the user to upgrade to paid support.

Another sample application is an electronic calling card. A business emails a button to a customer, hoping that the customer will use it to call the business when relevant products or services are needed. Depending on the circumstances, the business may arrange that all call costs associated with the use of the button are paid by the business and not by the customer. The button carries the logo of the business, so that it is readily recognisable to the customer. The button also has on or near it the name of the person whose telephone number is associated with the button, but the actual telephone number and other contact details are not displayed unless the customer specifically requests them, such as by right-clicking on the button. The software associated with the button may be such that, when the user acquires the button, the contact details for the person associated with the button are automatically entered in the user's personal contact management/address book software (if any). The buttons accumulated on the user's computer thus become a more user friendly and convenient version of, and/or integrated with, the address book software.

Rather than keeping buttons on the desktop, the user may elect to place them in a buttons folder or in a visual holder for buttons. The user could customise the appearance of a buttons collection to reflect the user's individual taste. In most cases, buttons will be of a standard size, but this is not essential, and businesses may choose to distinguish themselves by using buttons of unusual shapes and proportions.

Buttons contain, or have associated with them, data. This can be data sufficient to establish a telephone call It can also include other information such as the name of the company to be called, the identity of the end user, etc.

Value Added applications are possible by building more data into the button. A business could, for example, create an application which allows an end-user to make (say) $25 worth of telephone calls. One way of achieving this is to include a pseudo-random number in the button, in much the same way as is done with physical telephone Calling Cards. A remotely located server application could maintain a list of such numbers and debit the value associated with each number as calls were made, Alteratively, the residual value associated with a button may be stored within the button application itself in an appropriately encrypted form.

There may be date constraints associated with buttons. Thus, for example, a button can be inactive until made active at a certain time or date. Further, a button can have a use-by date, after which it will cease to work. The person who provided a button may remotely make a button active or inactive. Buttons can also have other constraints, which may limit such things as the time of day when they can be used, the numbers which they can be used to call, etc.

Although the first aspect of the invention relates to the application of establishing telephone calls, the buttons concept is not itself limited to this application. Buttons according to the second aspect of the invention can be used to conduct a broad range of transactions which may or may not require a payment. For example, a button may have an associated transaction relating to upgrading computer software. A user may purchase a button which entitles the user to one software upgrade. The user clicks the button, which connects the user to a web she from which the software upgrade can be downloaded, whereafter the button becomes inactive.

It is to be understood that various alterations, additions and/or modifications may be made to the parts and arrangements previously described without departing from the ambit of the invention.

1. A symbol for establishing a telephone call, having the following characteristics:
(a) the symbol appears on a computer display;
(b) a user can select and activate the symbol, which causes computer software and data associated with the symbol to activate telecommunications equipment which establishes the telephone call;
(c) the symbol is “portable”, in that a user can cause it to be moved from any one of the following locations:
(i) an Internet web page
(ii) an email message
(iii) a window associated with a computer program
(iv) a file directory folder
(v) an electronic form
(vi) a computer data storage medium
(vii) the user's operating system “desktop”
(viii) a personal digital assistant, Wireless Application Protocol phone or other mobile computing device
to one of the following locations:
(I) the users operating system “desktop”
(II) an email message
(III) a window associated with a computer program
(IV) a file directory folder
(V) an electronic form
(VI) a computer data storage medium
(VII) an Internet web page
(VIII) a personal digital assistant, Wireless Application Protocol phone or other mobile computing device;
(d) when the symbol is moved from one location to another, the computer software and data associated with the symbol are copied to the new location together with the symbol, the computer software and data being sufficient to facilitate the establishment of a telephone call.

2. A symbol according to claim 1 wherein visual representations of more than one of the locations mentioned in (c) are simultaneously present on a computer display and the process described in (d) is accomplished by means of a drag and drop action using a mouse or other input device.

3. A symbol according to claim 1 wherein the computer software which is activated when the symbol is selected and activated gives the user an option to select by name, number or function the telephone number to which the telephone call is to be established.

4. A symbol according to claim 1 wherein the symbol is associated with a single telephone number, and the computer software which is activated when the symbol is selected causes establishes a telephone call to that number.

5. A symbol according to claim 1 wherein the symbol has a stored value, and when the user uses the symbol to establish a telephone call, the stored value is reduced by an amount associated with the value of the telephone call.

6. A symbol according to claim 1 wherein the symbol acts as an indicator to the user that the user is required to make a telephone call to a particular number, and the symbol disappears or changes its appearance as the call is set up or after the user has used it to establish the telephone call.

7. A portable symbol with a stored value, having the following characteristics:
(a) the symbol appears on a computer display;
(b) a user can select and activate the symbol, which causes computer software and data associated with the symbol to conduct a transaction which has an associated cost;
(c) the symbol is “portable”, in that a user can cause it to be moved from any one of the following locations
(i) an Internet web page
(ii) an email message
(iii) a window associated with a computer program
(iv) a file directory folder
(v) an electronic form
(vi) a computer data storage medium
(vii) the user's operating system “desktop”
(viii) a personal digital assistant. Wireless Application Protocol phone or other mobile computing device
to one of the following locations:
(I) the user's operating system “desktop”
(II) an email message
(III) a window associated with a computer program
(IV) a file directory folder
(V) an electronic form
(VI) a computer data storage medium
(VII) an Internet web page
(VIII) a personal digital assistant, Wireless Application Protocol phone or other mobile computing device;
(d) when the symbol is moved from one location to another, the computer software and data associated with the symbol are copied to the new location together with the symbol, the computer software and data being sufficient to facilitate the transaction which has the associated cost;
(e) when a transaction is conducted, the associated cost is deducted from the stored value.

8. A portable symbol with a stored value according to claim 7 wherein visual representations of more than one of the locations mentioned in (c) are simultaneously present on a computer display and the process described in (d) is accomplished by means of a drag and drop action using a mouse or other input device.

9. A symbol according to claim 7 wherein the stored value is stored in a database remote from the location of the computer software associated with the symbol.

10. A symbol according to claim 7 wherein the stored value is stored as part of the computer software and data associated with the symbol.

11. A collection of symbols according to claim 7 wherein each symbol represents a different type of transaction or a transaction with a different person.

12. A collection of symbols according to claim 11 wherein the transactions associated with the symbols consist of or include establishing telephone calls.
